(19) United States
(12) Patent Application Publication
(10) Pub. No.: US 2012/0293648 A1
(43) Pub. Date: Nov. 22, 2012

(54) COMPONENT MOUNTING SYSTEM, IMAGE RECOGNITION DATA PREPARATION APPARATUS, AND IMAGE RECOGNITION DATA PREPARATION METHOD

(75) Inventors: Hirotake Nakayama, Yamanashi (JP); Atsushi Tanabe, Yamanashi (JP)

(73) Assignee: PANASONIC CORPORATION, Osaka (JP)

(21) Appl. No.: 13/378,494

(22) PCT Filed: May 19, 2011
(86) PCT No.: PCT/JP2011/002803

§ 371 Date: Dec. 15, 2011

(30) Foreign Application Priority Data
Jun. 24, 2010 (JP) 2010-143479

(51) Int. Cl. H04N 7/18

(52) U.S. Cl. 348/87; 348/E07.085

(57) ABSTRACT

It is an objective to provide a component mounting system capable of enhancing work efficiency by diminishing work load stemming from preparation of image recognition data, an image recognition data preparation apparatus, and an image recognition data preparation method. A line camera structurally similar to a line camera used in a component mounting machine outputs image data while a component is irradiated with reflective illumination light and transmissive illumination light. The thus-output image data are acquired and subjected to recognition processing, to thus prepare image recognition data on the basis of a result of recognition processing. Subsequently, a recognition test using the thus-prepared image recognition data is performed, thereby determining whether or not the image recognition data are appropriate. A recognition test which would be performed in an actual component mounting machine thereby becomes unnecessary. Data readjustment operation which would be required when a result of recognition test is determined to be inappropriate is precluded, so that work efficiency can be enhanced by diminishing work load stemming from preparation of image recognition data.

### TECHNICAL FIELD

The present invention relates to a component mounting system that mounts components on a substrate, to thus manufacture a mounted substrate, an image recognition data preparation apparatus that generates image recognition data used for image recognition by a component mounting apparatus which makes up the component mounting system, and an image recognition data preparation method.

### BACKGROUND ART

Image recognition employing pattern matching has been heavily used for detecting a position of a component, inspecting components, and the like, in the field of manufacture of electronic components and electronic equipment, like a component mounting system that manufactures a mounted substrate by mounting components on a substrate. In image recognition, a recognition image produced as a result of a recognition target being captured by a camera is matched with previously-prepared image recognition data, thereby specifying the shape and position of a recognition target, like a component. Preparation of image recognition data is carried out for each type of a recognition target. When a plurality of types of images are taken as recognition targets, image recognition data are prepared by use of a custom-designed data preparation apparatus each time (see; for instance, Patent Document 1). In the related art described in connection with the patent document, component suggestion data for specifying a shape of a component to suggest what the component is are generated from a color image of a component captured by a scanner. Thereby, an advantage of the ability to prepare data pertaining to a plurality of types of parts in a simple, offline manner is yielded.

### RELATED ART DOCUMENT

### Patent Document

Patent Document 1: JP-A-2007-12036

### DISCLOSURE OF THE INVENTION

### Problem that the Invention is to Solve

However, data preparation described in connection with the related art encounters a problem, like that will be mentioned below, attributable to the method for acquiring a component image. Specifically, in the previously mentioned related art, a component image is captured by means of a scanner. The component image acquisition technique greatly differs from an image acquisition technique employed in the component mounting apparatus in connection with conditions employed for specifying an image characteristic, like employed imaging means and lighting conditions, and the like. Therefore, even when processing is actually performed by use of the thus-prepared image recognition data, an appropriate recognition result is not necessarily yielded. For this reason, a recognition test intended for ascertaining whether or not an actual component mounting apparatus appropriately yields a recognition result by use of the hitherto-prepared data has been required. Hence, when the recognition test result is determined to be inappropriate, complicate data readjustment operation, like a change in lightning conditions, must be carried out. For this reason, preparing image recognition data entails consumption of much work load and time.

Accordingly, the present invention aims at providing a component mounting system, an image recognition data preparation apparatus, and an image recognition data preparation method that make it possible to enhance work efficiency by reducing workload required for preparing image recognition data.

### Means for Solving the Problem

A component mounting system of the present invention corresponds to a component mounting system that is built by connection of a plurality of component mounting machines by means of a LAN and that mounts components on a substrate, to thus manufacture a mounted substrate, wherein

the component mounting machines are equipped with an image recognition data preparation apparatus that prepares, from a recognition image obtained by imaging the component to be recognized, image recognition data used for recognizing the component; and

the image recognition data preparation apparatus includes

a line camera structurally similar to a line camera used for capturing an image of the component in each of the component mounting machines;

a component placing section that places the component so as to face the line camera;

a reflective illumination section that irradiates the component with illumination light from an imaging direction of the line camera and a transmissive illumination section that irradiates the component with illumination light from a direction opposite to the imaging direction;

an illumination changeover section which switches a mode of illumination for imaging between reflective illumination emitted by the reflective illumination section and transmissive illumination emitted by the transmissive illumination section;

a relative traveling mechanism that relatively moves the line camera in one direction with respect to the component placing section;

a recognition processing section that captures image data output from the line camera and subjects the thus-captured image data to recognition processing; and

a control section that controls the line camera, the relative traveling mechanism, the recognition processing section, and the illumination changeover section, thereby performing data preparation processing for preparing the image recognition data and recognition test processing for conducting a recognition test using the prepared image recognition data, to thus determine whether or not the image recognition data are appropriate.

An image recognition data preparation apparatus of the present invention corresponds to an image recognition data preparation apparatus in a component mounting system that manufactures a mounted substrate by mounting components on a substrate, in which the image recognition data preparation apparatus prepares image recognition data used by a component mounting machine making up the component mounting system in order to recognize the component from a recognition image obtained by imaging the component that is a target of recognition, the image recognition data preparation apparatus comprising:

a line camera structurally similar to a line camera used for imaging the component in the component mounting machine and a component placing section that places the component so as to face the line camera;

a reflective illumination section that irradiates the component with illumination light from an imaging direction of the line camera and a transmissive illumination section that irradiates the component with illumination light from a direction opposite to the imaging direction;

an illumination changeover section which switches a mode of illumination for imaging between reflective illumination emitted by the reflective illumination section and transmissive illumination emitted by the transmissive illumination section;

a relative traveling mechanism that relatively moves the line camera in one direction with respect to the component placing section;

a recognition processing section that captures image data output from the line camera and subjects the thus-captured image data to recognition processing; and

a control section that controls the line camera, the relative traveling mechanism, the recognition processing section, and the illumination changeover section, thereby performing data preparation processing for preparing the image recognition data and recognition test processing for conducting a recognition test using the prepared image recognition data, to thus determine whether or not the image recognition data are appropriate.

An image recognition data preparation method of the present invention corresponds to an image recognition data preparation method for preparing image recognition data used for recognizing a component from a recognition image obtained by imaging the component, which is a target of recognition, in a plurality of component mounting machines that make up a component mounting system for manufacturing a mounted substrate by mounting the component on a substrate and that are connected by means of a LAN, the method comprising:

a component placing step for placing the component on a component placing section so as to face a line camera structurally similar to a line camera used for capturing an image of the component in each of the component mounting machines;

a first scan step for relatively moving the line camera in one direction with respect to the component while the component is irradiate with transmissive illumination light from a direction opposite to an imaging direction of the line camera;

a second scan step for relatively moving the line camera in one direction with respect to the component while the component is irradiated with reflective illumination light from the imaging direction of the line camera;

a recognition processing step for capturing image data output from the line camera in the first scan step and the second scan step and subjecting the image data to recognition processing;

a data preparation step for preparing the image recognition data from a result of recognition processing; and

a recognition test step for performing a recognition test using the prepared image recognition data, thereby determining whether or not the image recognition data are appropriate.

### Advantage of the Invention

According to the present invention, a line camera structurally similar to a line camera used in a component mounting machine outputs image data while a component is irradiated with reflective illumination light and transmissive illumination light. The thus-output image data are acquired and subjected to recognition processing, to thus prepare image recognition data on the basis of a result of recognition processing. Subsequently, a recognition test using the thus-prepared image recognition data is performed, thereby determining whether or not the image recognition data are appropriate. A recognition test which would be performed in an actual component mounting machine thereby becomes unnecessary. Data readjustment operation which would be required when a result of recognition test is determined to be inappropriate is precluded, so that work efficiency can be enhanced by diminishing work load stemming from preparation of image recognition data.

### BRIEF DESCRIPTION OF THE DRAWINGS

FIG. 1 It is a descriptive view of a configuration of a component mounting system of an embodiment of the present invention.

FIG. 2 It is an oblique perspective view of a component mounting machine in the component mounting system of the embodiment of the present invention.

FIG. 3 It is a plan view of the component mounting machine in the component mounting system of the embodiment of the present invention.

FIG. 4 It is a descriptive view of component imaging operation performed by the component mounting machine of the embodiment of the present invention.

FIG. 5 It is a descriptive view of a configuration of an image recognition data preparation apparatus of the embodiment of the present invention.

FIG. 6 It is a descriptive view of a configuration of the image recognition data preparation apparatus of the embodiment of the present invention.

FIG. 7 It is a block diagram showing a configuration of a control system of the image recognition data preparation apparatus of the embodiment of the present invention.

FIG. 8 It is a flowchart of an image recognition data preparation method of the embodiment of the present invention.

FIG. 9(a) to (f) they are graphical explanatory views showing the image recognition data preparation method of the embodiment of the present invention.

### EMBODIMENT FOR IMPLEMENTING THE INVENTION

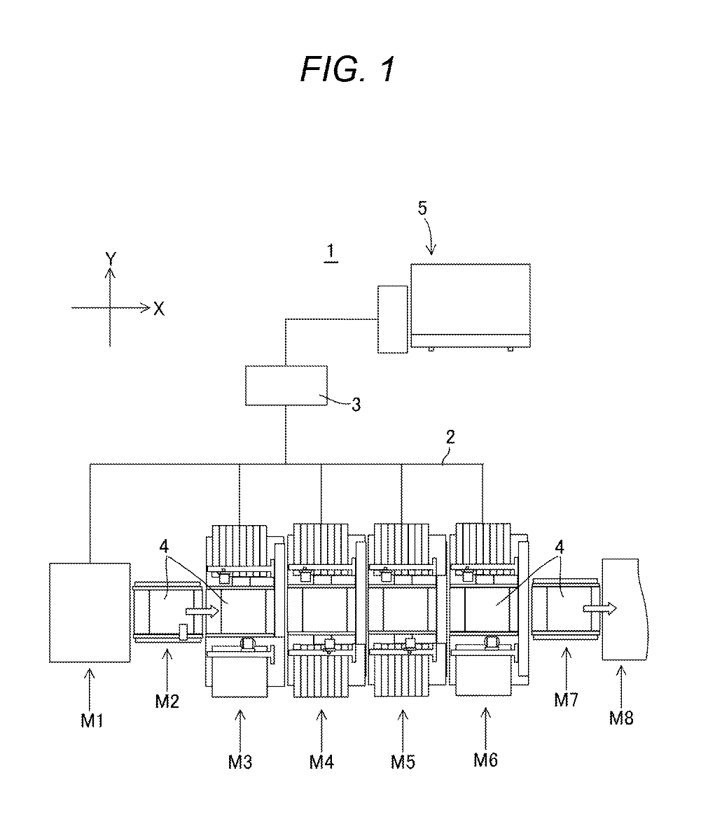

An embodiment of the present invention is now described by reference to the drawings. First, a component mounting system 1 that mounts components on a substrate, to thus manufacture a mounted substrate, is described by reference to FIG. 1. In FIG. 1, the component mounting system 1 predominantly includes a component mounting line built by joining machines (machines for mounting components), like a printing machine M1, a substrate delivery-and-receipt machine M2, an inspection-and-mounting machine M3, component mounting machines M4 and M5, an inspection-and-mounting machine M6, a substrate delivery-and-receipt machine M7, and a reflow machine M8, in a substrate conveyance direction (a direction X) along which a substrate 4 that is a target of operation is to be conveyed.

The machines making up the component mounting line are connected together by means of a communication network 2 (LAN) and controlled by a host machine 3 having the function of a supervisory computer. The host machine 3 is provided with an image recognition data preparation apparatus 5. The image recognition data preparation apparatus 5 has a function of preparing image recognition data that the inspection-and-mounting machines M3 and M6 and the component mounting machines M4 and M5 use to recognize a component from a recognition image obtained as a result of imaging of a component to be recognized. The image recognition data prepared by the image recognition data preparation apparatus 5 are transmitted to each of the component mounting machines by way of the host machine 3 and the communication network 2.

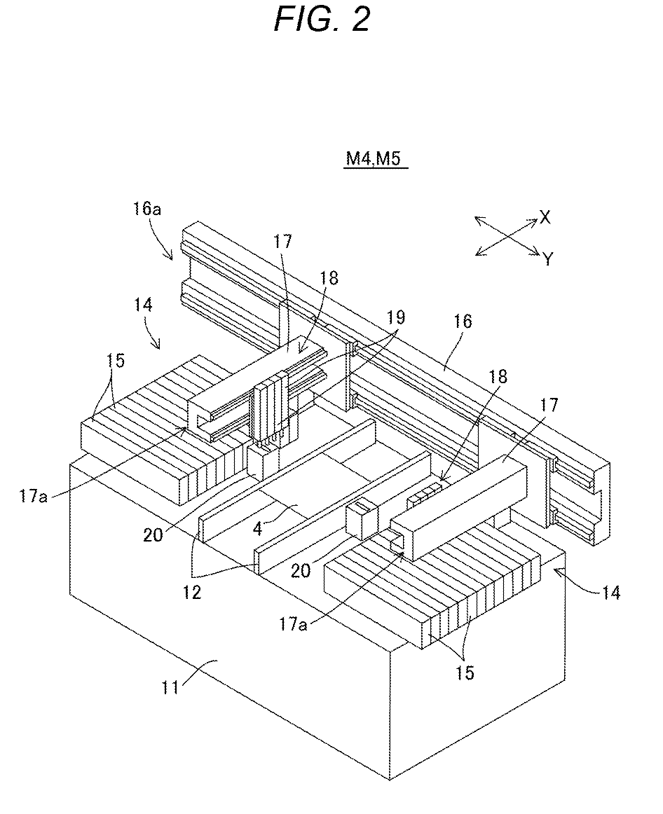

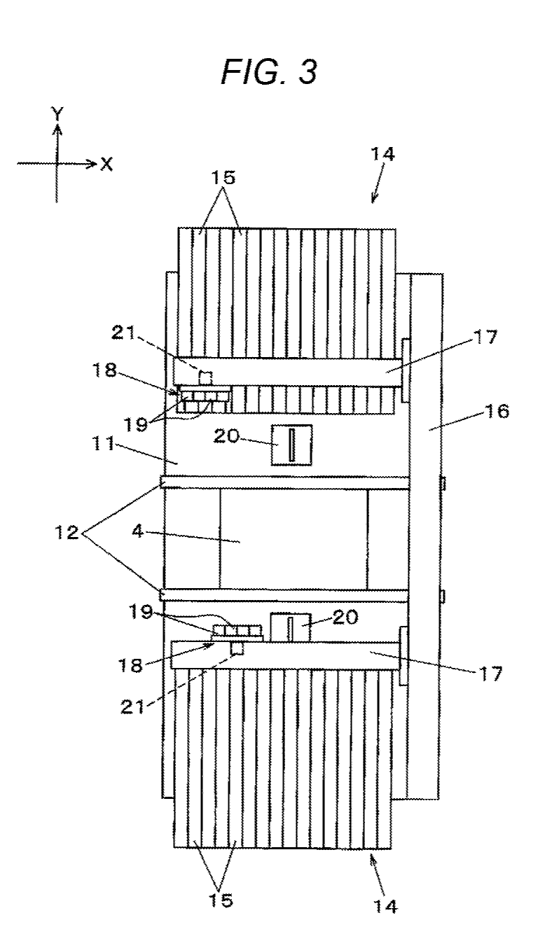

By reference to FIGS. 2 and 3, a component mounting function of the component mounting system 1 is now described. Although a configuration of the component mounting machines M4 and M5 is illustrated, the same also applies to a component mounting function of the inspection-and-mounting machines M3 and M6. In FIGS. 2 and 3, a substrate conveyance mechanism 12 is disposed on an upper snake of a bench 11 along the substrate conveyance direction (the direction X). The substrate conveyance mechanism 12 conveys the substrate 4 that is a target of mounting operation, positioning and holding the substrate 4 at a mounting operation position for a component mounting mechanism to be described later.

A component feed block 14 is placed on either side of the substrate conveyance mechanism 12, and a plurality of tape feeders 15 are placed side by side in each of the component feed blocks 14. The tape feeder 15 sends a carrier tape holding components to be mounted, by means of a pitch feed, thereby feeding the component to a position where a mount head picks up the thus-fed component. A Y-axis transfer table 16 equipped with a linear driving mechanism 16a is placed along a direction Y at one end of the upper surface of the bench 11 in the direction X. Two X-axis transfer tables 17 are attached to the Y-axis transfer table 16 so as to be movable in the direction Y. A mount head 18 is attached to each of the X-axis transfer tables 17 so as to be movable in the direction X by means of a linear drive mechanism 17a.

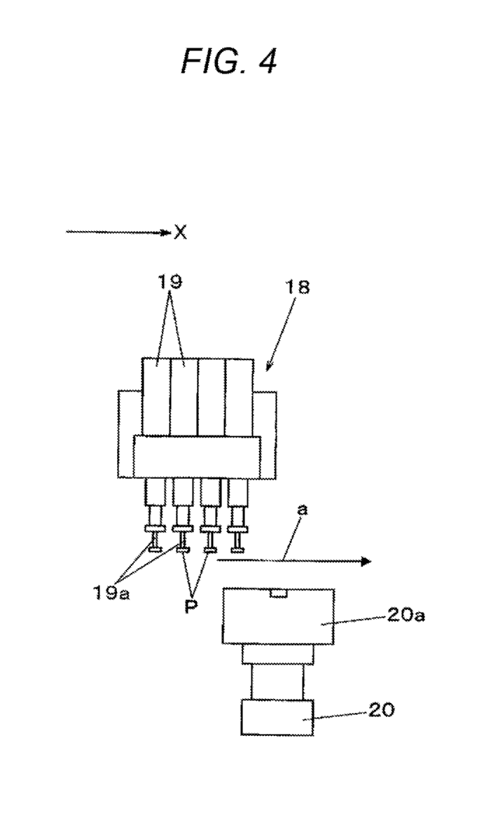

Each of the mount heads 18 is a multiple head including a plurality of unit transfer heads 19 (four heads in the embodiment). A pickup nozzle 19a (see FIG. 4) for picking up a component P by suction is attached to a lower end of each of the unit transfer heads 19. As a result of movement of the Y-axis transfer table 16 and the X-axis transfer tables 17, the two mount heads 18 are horizontally transferred in both the X and Y directions, to thus pickup the components P from the respective component feed blocks 14 and mount the thus-picked-up components P onto the substrate 4 positioned and held by the substrate conveyance mechanism 12. The Y-axis transfer table 16 and the X-axis transfer tables 17 make up a head transfer mechanism that transfers the mount heads 18.

Line cameras 20, each of which has a reflective recognition illumination device 20a, are disposed with their imaging surfaces up along travel paths of the respective mount heads 18 in the head transfer mechanism. As shown in FIG. 4, each of the mount head 18 that holds the components P by means of its pickup nozzles 19a travels in a scan direction (the X direction) over the line camera 20 (as designated by arrow “a”), whereby the line camera 20 captures an image of the component P held by the suction nozzle 19a and illuminated by the reflective recognition illumination device 20a. A substrate recognition camera 21 that travels along with the mount head 18 in an integrated fashion is positioned, on an underside of each of the X-axis transfer tables 17, with its imaging surface oriented downward. The substrate recognition camera 21 travels over the substrate 4 along with its corresponding mount head 18, thereby capturing an image of the substrate 4 and a component mounting point set on the substrate 4. During operation for mounting the components P by the mount heads 18, the mount heads 18 position the components P according to results of recognition of the data captured by the line cameras 20 and the substrate recognition cameras 21.

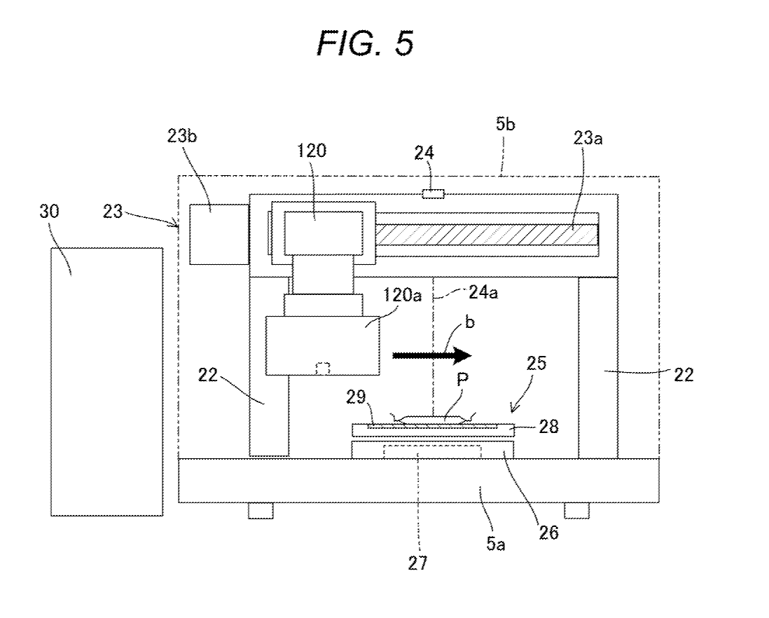

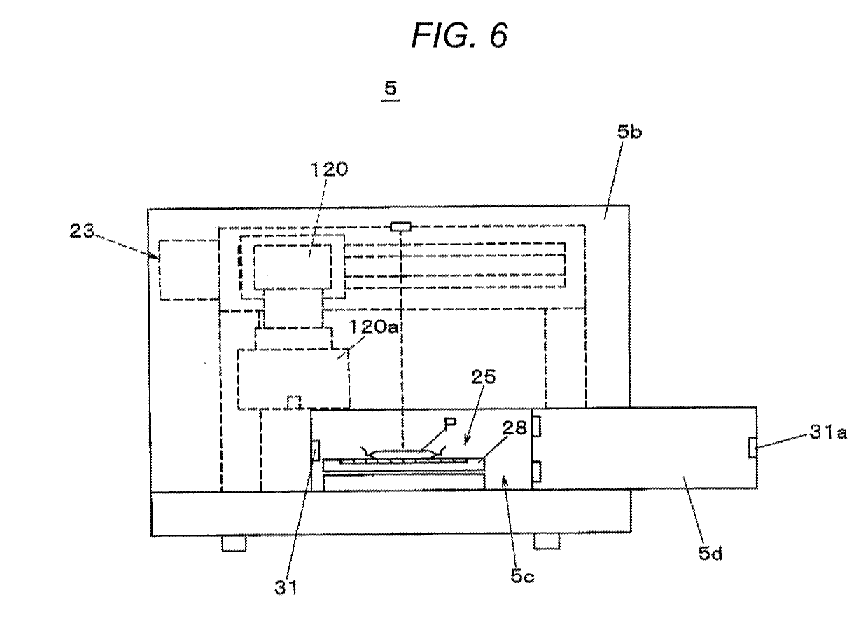

By reference to FIGS. 5 and 6, the configuration of the image recognition data preparation apparatus 5 is now described. As shown in FIG. 5, the image recognition data preparation apparatus 5 is equipped with a safety cover 5b that surrounds a space above a base 5a, and elements which will be described below are arranged within the safety cover 5b. Further, a controller 30 is attached to the image recognition data preparation apparatus 5. A single axis transfer table 23 configured so as to rotationally drive a ball screw 23a by means of a line camera drive motor 23b is provided so as to extend between support posts 22 standing upright on the base 5a. The single axis transfer table 23 is equipped with a line camera 120 structurally similar to the line camera 20 used for capturing an image of a component in each of the component mounting machines of the component mounting system 1. The line camera 120 is positioned with its imaging direction oriented down and has a reflective recognition illumination device 120a structurally similar to the reflective recognition illumination device 20a. As a result of the single axis transfer table 23 being driven, the line camera 120 horizontally moves along arrow direction “b” with respect to a component placing section 25 to be described below, whereupon there is performed scanning operation for the line camera 120 to capture an image of the component P placed on the component placing section 25. Consequently, the single axis transfer table 23 has a relative transfer mechanism for relatively traveling the line camera 120 in one direction with respect to the component mount section 25.

The component placing section 25 used for positioning the component P so as to face the line camera 120 is disposed on an upper surface of the base 5a. The component placing section 25 has a structure in which a lower table 26 incorporating a transmissive recognition illumination device 27 is placed beneath an underside of an elevation table 28 that holds the component P. A vertical position of the elevation table 28 is variable with respect to the lower table 26, whereby the height of the component P can thereby be set to a focusing position of the line camera 120. A selective transmission plate 29 is attached to an upper surface of the elevation table 28. The selective transmission plate 29 possesses an optical characteristic of allowing upward transmission of illumination light originating from the transmissive recognition illumination device 27 and preventing upward reflection of illumination light originating from the reflective recognition illumination device 120a.

During capture of an image of the component P performed by the line camera 120, the transmissive recognition illumination device 27 is activated, whereby illumination light is emitted upward while passing through the elevation table 28. An image of the component P made by transmission illumination is thereby acquired. Moreover, the illumination light emitted downwardly as a result of activation of the reflective recognition illumination device 120a does not undergo reflection on the selective transmission plate 29 but is reflected upward by means of only the component P, whereby a reflective illumination image of the component P is acquired. The reflective recognition illumination device 120a and the transmissive recognition illumination device 27 act respectively as a reflective illumination device and a transmissive illumination device that emits illumination light to the component P in an imaging direction of the line camera 120 and a direction opposite to the imaging direction.

An LED pointer 24 is disposed at a location above a position at which the component placing section 25 places the component P. An operator visually ascertains a point of irradiation of an optical axis 24a emitted downwardly from the LED pointer 24, whereby there is indicated a location where the component P is to be placed by the component placing section 25. As shown in FIG. 6, a load-unload opening 5c that is a partial cutout made in the safety cover 5b so as to allow loading and unloading of the component P is formed in a front surface of the component placing section 25. The load-unload opening 5c is made reclosable by an open-close door 5d. The open-close door 5d is provided with a cover open-close detection switch SW 31. When the open-close door 5d is situated at a close position, the cover open-close detection switch SW 31 detects a detection section 31a, thereby detecting an open/close state of the open-close door 5d.

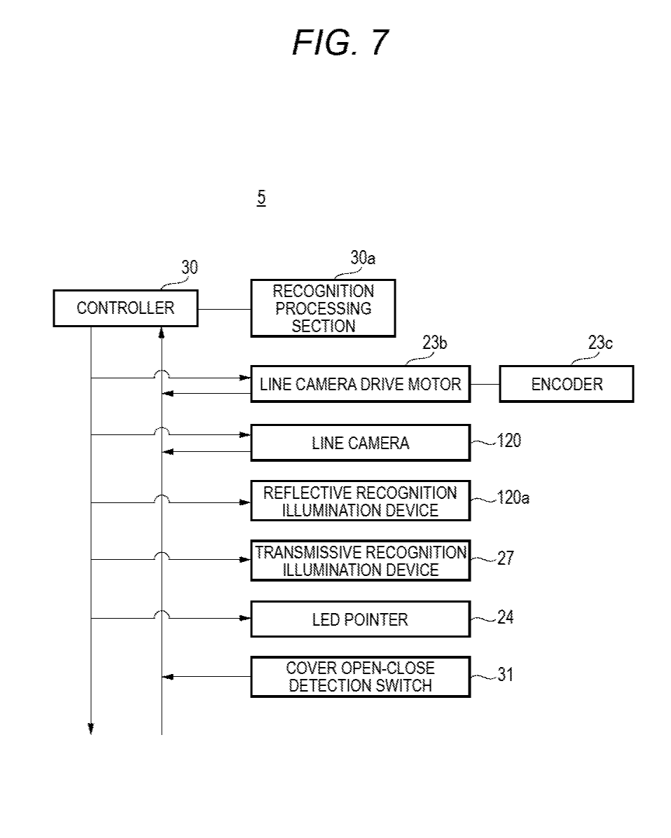

By reference to FIG. 7, a configuration of a control system of the image recognition data preparation apparatus 5 is now described. In FIG. 7, the controller 30 is connected to the line camera drive motor 23b, the line camera 120, the reflective recognition illumination device 120a, the transmissive recognition illumination device 27, the LED pointer 24, and the cover open-close detection switch SW 31. The controller 30 additionally includes, as an internal function, a recognition processing section 30a. While receiving a feedback signal from an encoder 23c provided in the line camera drive motor 23b, the controller 30 controls the line camera drive motor 23b and the line camera 120, thereby performing scanning operation for acquiring an image of the component P while relatively moving the line camera 120 with respect to the component P put on the component placing section 25. During imaging operation, the controller 30 switches between the reflective recognition illumination device 120a and the transmissive recognition illumination device 27, thereby switching an illumination mode during imaging operation. Consequently, the controller 30 acts as an illumination changeover section that switches the illumination mode employed during imaging between reflective illumination performed by the reflective recognition illumination device 120a and transmissive illumination performed by the transmissive recognition illumination device 27. A detection result of the cover open-close detection switch SW 31 is interlocked with operation of the single axis transfer table 23. While opening of the open-close door 5d is detected, the single axis transfer table 23 is prohibited from moving the line camera 120.

The recognition processing section 30a subjects, to image recognition processing, image data output from the line camera 120, thereby preparing image recognition data that will be used for recognizing an image by each of the component mounting machines of the component mounting system 1. The controller 30 of the image recognition data preparation apparatus 5 determines whether or not the thus-prepared image recognition data are appropriate. Specifically, the controller 30 has a function of controlling the line camera 120, the single axis transfer table 23, and the recognition processing section 30a, thereby carrying out data preparation processing for preparing image recognition data and recognition test processing for conducting a recognition test using the thus-prepared image recognition data, to thus determine whether or not the image recognition data are appropriate.

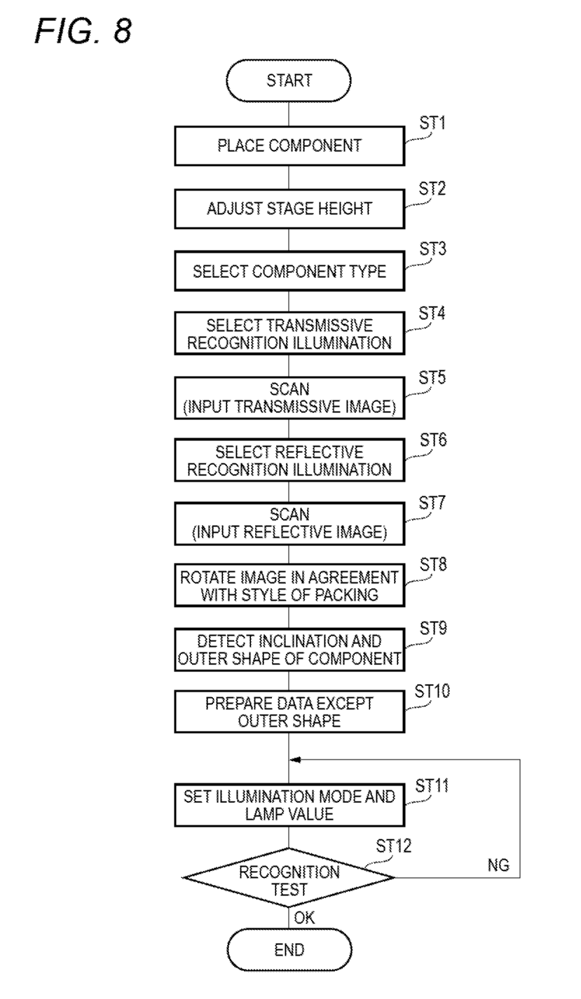

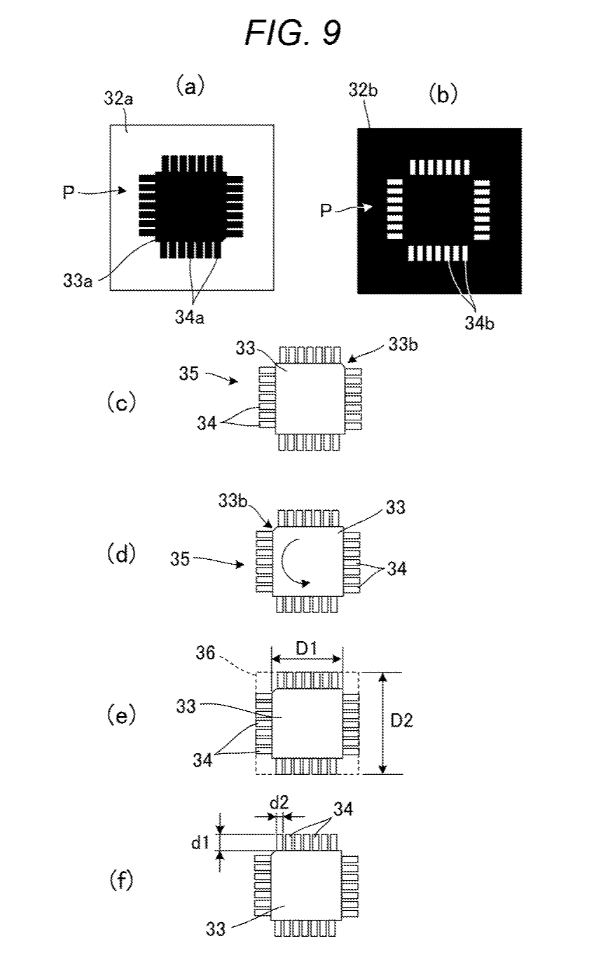

By reference to FIGS. 8 and 9(a) to 9(f), an explanation is given to an image recognition data preparation method for preparing image recognition data with the image recognition data preparation apparatus 5 in the component mounting machines making up the component mounting system 1. In FIG. 8, placing a component is first carried out (ST1). Specifically, the component P is placed on the component placing section 25 so as to face the line camera 120 structurally similar to the line camera 20 used for capturing an image of the component P in each of the component mounting machines (a component placing step). Next, a stage height is adjusted (ST2), to thus make a height of the component P held on the elevation table 28 by means of the component placing section 25 coincide with an imaging height of the line camera 120. Subsequently, the open-close door 5d is closed, whereby the line camera 120 becomes able to perform imaging operation. Next, selecting a component type is performed (ST3). That is, a type of a component to be recognized is selectively input on an input screen, to thereby be specified. A previously-specified lamp value for illumination is thereby set according to a component type.

Then, an image acquired by imaging of the component P is input. First, transmissive recognition illumination is selected as the illumination mode (ST4). Scan operation for imaging purpose is performed (a transmissive image is input) while the transmissive recognition illumination device 27 illuminates the component P from below (ST5). The line camera 120 is relatively moved with respect to the component P in one direction while the transmissive recognition illumination device 27 is emitting transmission illumination light on the component P from a direction opposite to the imaging direction of the line camera 120 (a first scan step). A transmissive image 32a is thereby acquired. In the transmissive image 32a, a mold body 33 and leads 34 of the component P appear as dark images 33a and 34a in a background image that is a blight image.

Next, in a state in which reflective recognition illumination is selected as the illumination mode (ST6) and in which the component P is irradiated, from above, with reflective illumination light from the reflective recognition illumination device 120a, scan operation for imaging purpose is performed (a reflective image is input) (ST7). Specifically, while the component P is irradiated with reflective illumination light from the imaging direction of the line camera 120, the line camera 120 is relatively moved in one direction with respect to the component P (a second scan step). A reflective image 32b shown in FIG. 9(b) is thus acquired. In the reflective image 32b, the leads 34 of the component P appear as bright images 34b in the background image that is a dark image.

Image data output from the line camera 120 in the first can step and the second scan step are then acquired and subjected to recognition processing (in a recognition processing step). Processing provided below is now performed. Specifically, the transmissive image 32a and the reflective image 32b shown in FIGS. 9(a) and 9(b) are first combined together, whereby a recognition image 35 shown in FIG. 9(c) is produced. Thus, by means of combination of the transmissive image 32a and the reflective image 32b having different image characteristics, it becomes possible to acquire the recognition image 35 precisely reflecting a geometrical characteristic of the component P that is a target of recognition. Next, the recognition image 35 is rotated in agreement with a style of packing by means of which the component P is placed on the substrate 4 (ST8). Specifically, as shown in FIG. 9(d), a corner cut 33b in a mold body 33 moves to a position achieved when the component P is picked up by suction by means of a nozzle in the mounting machine

Image recognition data used for recognizing the component P are prepared from a result of recognition processing mentioned above (a data preparation step). For instance, processing to be described below is carried out. That is, an inclination and an outer shape of the component P are first detected (ST9). Specifically, a basic geometry and dimension of the component P to become a target of recognition are detected. FIG. 9(e) illustrates an example in which a dimension D1 of the mold body 33 and an entire outer dimension D2 of the component including the leads 34 are determined. Data except the outer dimension are then prepared (ST10). As shown in FIG. 9(f), there is shown an example in which the width d1 of the leads 34 and a dimension d2 of an extension are determined. It is better to determine, as required, which of the dimensional elements of the recognition image 35 is taken as a target of detection while taking into account a shape and a characteristic of the component P.

Subsequently, the image recognition data preparation apparatus 5 performs a recognition test using the thus-prepared image recognition data, thereby determining whether or not the image recognition data are appropriate (a recognition test step). First, an illumination mode and a lamp value are set (ST11). More specifically, a more appropriate illumination mode is selected on the occasion of recognition of the component P. The lamp value of the illumination device is also set according to previously specified illumination condition data. A recognition test is then performed (ST12), thereby determining whether or not a recognition result is OK or NG. Specifically, the line camera 120 captures an image of the component P in the selected illumination mode while the component P is illuminated at the selected lamp value: The thus-acquired image data are subjected to recognition processing, thereby determining whether or not a desired recognition result can be yielded.

When the recognition result is NG, processing returns to (ST11), where the illumination mode and the lamp value are newly set. The recognition test is again performed. When the recognition result is determined to be OK in (ST12), image recognition data preparation processing completes. The thus-prepared image recognition data are transmitted to the respective component mounting machines making up the component mounting system 1 by way of the host machine 3 and the communication network 2.

As previously mentioned, in the present embodiment, the line camera 120 structurally similar to the line camera 20 used in the component mounting machine outputs image data while the component is irradiated with the reflective illumination light and the transmissive illumination light. The thus-output image data are acquired and subjected to recognition processing. A recognition test using the image recognition data prepared from a result of recognition processing is carried out, thereby determining whether or not the image recognition data are appropriate. A recognition test of an actual component mounting machine that has hitherto been required becomes unnecessary. Data readjustment operation, which would be required when the recognition test result is determined to be inappropriate, is precluded, so that work efficiency can be enhanced while work load stemming from preparation of image recognition data is diminished.

Although the present invention has been described in detail by reference to the specific embodiment, it is manifest to those skilled in the art that present invention be susceptible to various alterations or modifications without departing the spirit and scope of the present invention.

The present patent application is based on Japanese Patent Application (JP-2010-143479) filed on Jun. 24, 2010, the entire subject matter of which is incorporated herein by reference.

### INDUSTRIAL APPLICABILITY

The component mounting system, the image recognition data preparation apparatus, and the image recognition data preparation method of the present invention yield an advantage of the ability to diminish work load stemming from preparation of image recognition data, to thus enhance work efficiency. Thus, they are useful in a field of a component mounting technique where a mounted substrate is manufactured by mounting components on a substrate.

### Descriptions of the Reference Numerals and Symbols

1 COMPONENT MOUNTING SYSTEM
2 COMMUNICATION NETWORK
3 HOST MACHINE
4 SUBSTRATE
5 IMAGE RECOGNITION DATA PREPARATION APPARATUS
18 MOUNT HEAD
20, 120 LINE CAMERA
20a, 120a REFLECTIVE RECOGNITION ILLUMINATION DEVICE
23 SINGLE AXIS TRANSFER TABLE
25 COMPONENT PLACING SECTION
27 TRANSMISSIVE RECOGNITION ILLUMINATION DEVICE
P COMPONENT
M4, M5 COMPONENT MOUNTING MACHINE

1. A component mounting system that is built by connection of a plurality of component mounting machines by means of a LAN and that mounts components on a substrate, to thus manufacture a mounted substrate, wherein
the component mounting machines are equipped with an image recognition data preparation apparatus that prepares, from a recognition image obtained by imaging the component to be recognized, image recognition data used for recognizing the component; and
the image recognition data preparation apparatus includes
a line camera structurally similar to a line camera used for capturing an image of the component in each of the component mounting machines;
a component placing section that places the component so as to face the line camera;
a reflective illumination section that irradiates the component with illumination light from an imaging direction of the line camera and a transmissive illumination section that irradiates the component with illumination light from a direction opposite to the imaging direction;
an illumination changeover section which switches a mode of illumination for imaging between reflective illumination emitted by the reflective illumination section and transmissive illumination emitted by the transmissive illumination section;
a relative traveling mechanism that relatively moves the line camera in one direction with respect to the component placing section;
a recognition processing section that captures image data output from the line camera and subjects the thus-captured image data to recognition processing; and
a control section that controls the line camera, the relative traveling mechanism, the recognition processing section, and the illumination changeover section, thereby performing data preparation processing for preparing the image recognition data and recognition test processing for conducting a recognition test using the prepared image recognition data, to thus determine whether or not the image recognition data are appropriate.

2. An image recognition data preparation apparatus in a component mounting system that manufactures a mounted substrate by mounting components on a substrate, in which the image recognition data preparation apparatus prepares image recognition data used by a component mounting machine making up the component mounting system in order to recognize the component from a recognition image obtained by imaging the component that is a target of recognition, the image recognition data preparation apparatus comprising:
a line camera structurally similar to a line camera used for imaging the component in the component mounting machine and a component placing section that places the component so as to face the line camera;
a reflective illumination section that irradiates the component with illumination light from an imaging direction of the line camera and a transmissive illumination section that irradiates the component with illumination light from a direction opposite to the imaging direction;
an illumination changeover section which switches a mode of illumination for imaging between reflective illumination emitted by the reflective illumination section and transmissive illumination emitted by the transmissive illumination section;
a relative traveling mechanism that relatively moves the line camera in one direction with respect to the component placing section;
a recognition processing section that captures image data output from the line camera and subjects the thus-captured image data to recognition processing; and
a control section that controls the line camera, the relative traveling mechanism, the recognition processing section, and the illumination changeover section, thereby performing data preparation processing for preparing the image recognition data and recognition test processing for conducting a recognition test using the prepared image recognition data, to thus determine whether or not the image recognition data are appropriate.

3. An image recognition data preparation method for preparing image recognition data used for recognizing a component from a recognition image obtained by imaging the component, which is a target of recognition, in a plurality of component mounting machines that make up a component mounting system for manufacturing a mounted substrate by mounting the component on the substrate and that are connected by means of a LAN, the method comprising:
a component placing step for placing the component on a component placing section so as to face a line camera structurally similar to a line camera used for capturing an image of the component in each of the component mounting machines;
a first scan step for relatively moving the line camera in one direction with respect to the component while the component is irradiate with transmissive illumination light from a direction opposite to an imaging direction of the line camera;
a second scan step for relatively moving the line camera in one direction with respect to the component while the component is irradiated with reflective illumination light from the imaging direction of the line camera;
a recognition processing step for capturing image data output from the line camera in the first scan step and the second scan step and subjecting the image data to recognition processing;
a data preparation step for preparing the image recognition data from a result of recognition processing; and
a recognition test step for performing a recognition test using the prepared image recognition data, thereby determining whether or not the image recognition data are appropriate.
